(19) United States
(12) Patent Application Publication
(10) Pub. No.: US 2026/0019202 A1
(43) Pub. Date: Jan. 15, 2026

(54) SYSTEMS, APPARATUSES, METHODS, AND NON-TRANSITORY COMPUTER-READABLE STORAGE DEVICES FOR WIRELESS COMMUNICATION EMPLOYING ENHANCED LONG-RANGE FRAME FORMAT

(71) Applicant: HUAWEI TECHNOLOGIES CO., LTD., Shenzhen (CN)

(72) Inventors: Jung Hoon Suh, Kanata (CA); Yan xin, Kanata (CA); Osama Aboul-Magd, Kanata (CN); Sara Norouzi, Vancouver (CA); Mahmoud Hasabelnaby, Kanata (CA)

(21) Appl. No.: 18/958,683

(22) Filed: Nov. 25, 2024

Related U.S. Application Data
(60) Provisional application No. 63/668,867, filed on Jul. 9, 2024.

(51) Int. Cl. H04L 5/00

(52) U.S. Cl. CPC H04L 5/0044; H04L 5/0007

(57) ABSTRACT

A communication method has the step of: transmitting or receiving a physical layer protocol data unit (PPDU); wherein the PPDU has a legacy signal (L-SIG) field, at least one enhanced long range (ELR) short training field (ELR-STF), or a combination thereof for avoiding double detection of the PPDU; wherein the L-SIG field comprises a rate subfield indicating a rate different to 6 megabits per second (Mbps), and a length subfield whose value modulo 3 is nonzero; and wherein each of the at least one ELR-STF has a short training sequence (STS) corresponding to a predefined or predetermined number of repeated pulses over a predefined or predetermined time period.

### CROSS-REFERENCE TO RELATED APPLICATION

This application claims the benefit of U.S. Provisional Patent Application Ser. No. 63/668,867, filed Jul. 9, 2024, the content of which is incorporated herein by reference in its entirety.

### FIELD OF THE DISCLOSURE

The present disclosure relates generally to communication systems, apparatuses, methods, and non-transitory computer-readable storage devices, and in particular to systems, apparatuses, methods, and non-transitory computer-readable storage devices for wireless communication employing enhanced long-range frame format.

### BACKGROUND

Wireless communication systems such as IEEE 802.11 series (that is, WI-FI® series; WI-FI is a registered trademark of Wi-Fi Alliance, Austin, TX, USA) are known. In future Ultra High Reliability (UHR) wireless communication systems (such as IEEE 802.11bn or WI-FI® 8 systems), it is important to have a solution on the Long Range and Ultra Reliable packet design to meet the requirements (such as those described in relevant project authorization request (PARs)).

IEEE 802.11-24/873r0, entitled “Design Targets and Considerations for Enhanced Long Range,” to Liu, et al. shows a high-level frame format (denoted “enhanced long range (ELR) frame format”) and some design criteria on this Long Range and Ultra Reliable packet transmission. It is reasonable to set the ELR design criteria as 20 megahertz (MHz) bandwidth (BW), single stream only, modulation and coding system (MCS) 0/1, and no beamforming (BF) to achieve the high reliability transmission. That is, the ELR is targeted to the UHR devices with the limited computational capability.

However, IEEE 802.11-24/873r0 does not provide any details of the ELR frame format.

### SUMMARY

According to one aspect of this disclosure, there is provided a communication method comprising: transmitting or receiving a physical layer protocol data unit (PPDU); wherein the PPDU comprises a first, legacy preamble, a second preamble, and a data piece; wherein the first preamble comprises a legacy signal (L-SIG) field; and wherein the L-SIG field comprises a rate subfield indicating a rate different to 6 megabits per second (Mbps), and a length subfield whose value modulo 3 is nonzero.

In some embodiments, the PPDU is an orthogonal frequency-division multiple access (OFDMA) PPDU; the second preamble comprises a long training field (LTF) portion; the LTF portion comprises a symbol in a plurality of tones; and half of the plurality of tones of the symbol are for carrying signal (SIG) information and another half of the plurality of tones of the symbol are for carrying long training sequences (LTS).

In some embodiments, the LTF portion comprises a first symbol for carrying signal (SIG) information and long training sequences (LTS); and, in the first symbol, the SIG information and the LTS are distributed in a plurality of tones such that each pair of neighboring tones for carrying the SIG information are spaced by at least one tone for carrying the LTS.

In some embodiments, the PPDU comprises a legacy signal (L-SIG) field, at least one enhanced long range (ELR) short training field (ELR-STF), or a combination thereof for avoiding double detection of the PPDU; the L-SIG field comprises a rate subfield indicating a rate different to 6 megabits per second (Mbps), and a length subfield whose value modulo 3 is nonzero; and each of the at least one ELR-STF comprises a short training sequence (STS) corresponding to a predefined or predetermined number of repeated pulses over a predefined or predetermined time period.

In some embodiments, the predefined or predetermined time period is 16 microseconds (μs).

In some embodiments, the first 6 or 7 pluses of the 10 repeated pulses are used for packet detection (PD), and the remaining pulses of the 10 repeated pulses are used for coarse carrier frequency offset (CFO) correction.

In some embodiments, the PPDU comprises two ELR-STFs, thereby giving rise to two STS.

In some embodiments, the two STS correspond to 20 repeated pulses over two predefined or predetermined time periods.

In some embodiments, the first 6 or 7 pluses of the 20 repeated pulses are used for PD, and the remaining pulses of the 20 repeated pulses are used for coarse CFO correction.

In some embodiments, the STS is a High Efficiency (HE) WLAN short training sequence HE STS.

In some embodiments, the HE STS is HES_{-120:8:120}={M, 0, −M}·(1+j)/\sqrt{2}, where M={−1, −1, −1, 1, 1, 1, −1, 1, 1, 1, −1, 1, 1, −1, 1}.

In some embodiments, the PPDU is an orthogonal frequency-division multiple access (OFDMA) PPDU; the PPDU comprises a long training field (LTF) portion; the LTF portion comprises a first symbol for carrying signal (SIG) information and long training sequences (LTS); and, in the first symbol, the SIG information and the LTS are distributed in a plurality of tones such that each pair of neighboring tones for carrying the SIG information are spaced by at least one tone for carrying the LTS.

In some embodiments, the LTF portion further comprises a second symbol also for carrying the SIG information and the LTS; wherein, in the second symbol, the SIG information and the LTS are distributed in the plurality of tones such that each pair of neighboring tones for carrying the SIG information are spaced by at least one tone for carrying the LTS; and wherein the tones carrying the SIG information in the first symbols are different to the tones carrying the SIG information in the second symbols.

According to one aspect of this disclosure, there is provided an apparatus comprising: one or more non-transitory, computer-readable storage media; and one or more processors functionally connected to the one or more non-transitory, computer-readable storage media; wherein the one or more non-transitory, computer-readable storage media comprising computer-executable instructions; and wherein the instructions, when executed, cause the one or more processors to perform any of the above-described methods and/or any of the methods disclosed herein.

According to one aspect of this disclosure, there is provided one or more non-transitory, computer-readable storage media comprising computer-executable instructions; wherein the instructions, when executed, cause the one or more processors to perform any of the above-described methods and/or any of the methods disclosed herein.

According to one aspect of this disclosure, there is provided one or more circuits such as one or more processors for performing the above-described methods.

According to one aspect of this disclosure, there is provided one or more processors functionally connected to one or more memories for performing the above-described methods.

According to one aspect of this disclosure, there is provided an apparatus comprising: one or more processors functionally connected to one or more memories for performing the above-described methods.

According to one aspect of this disclosure, there is provided an apparatus, and configured to perform the any of above mentioned methods and their embodiments. Specifically, the apparatus includes one or more units configured to perform the any of above mentioned methods and their embodiments.

According to one aspect of this disclosure, there is provided a computer-readable storage medium. The computer-readable storage medium stores a computer program, and when the computer program is executed by an apparatus, the apparatus is enabled to implement the any of above mentioned methods and their embodiments.

According to one aspect of this disclosure, there is provided a computer program product including one or more instructions. When the instructions are executed by an apparatus such as a computer, the apparatus is enabled to implement the any of above mentioned methods and their embodiments.

According to one aspect of this disclosure, there is provided a computer program. When the computer program is executed by a computer, an apparatus is enabled to implement the any of above mentioned methods and their embodiments.

According to one aspect of this disclosure, there is provided a communication system. The communication system includes a first communication-node and/or a second communication-node, the first communication-node is configured to perform the methods regarding with the first communication-node as stated above, and the second communication-node is configured to perform the methods regarding with the second communication-node as stated above.

According to one aspect of this disclosure, there is provided an apparatus for implementing the methods in any possible implementation of the foregoing aspects.

Herein, various embodiments of the enhanced long range (ELR) frame format and communication method using the ELR frame format are disclosed. In some embodiments, the communication method disclosed herein assigns 256 subcarriers per 20 MHz for the ELR preamble portion (including the pure data portion), which provides frame efficiency and easier packet detection.

In some embodiments, the ELR short training field (ELR-STF) may be defined using the High Efficiency (HE) WLAN short training sequence (HE STS) of HE trigger-based (TB) PPDU, thereby providing improved packet detection and coarse carrier frequency offset (CFO) correction.

In some embodiments, the communication method disclosed herein indicates the ELR frame in the legacy portion to avoid the double packet detection case which may otherwise occur with the legacy STF (L-STF) and ELR-STF, in case ELR-STF creates the same number of samples being repeated over a time period as the L-STF. Thus, when the packet detection periods are the same between L-STF and ELR-STF, the ELR frame provides indication in the legacy preamble portion, which provides the solution to avoid the double packet detection.

In some embodiments, the communication method disclosed herein allocates the ELR signal (ELR-SIG) field in the staggered LTF portion and may repeat the ELR-SIG as needed, thereby avoiding the overhead issue in the ELR frame with the repeated SIG field.

### BRIEF DESCRIPTION OF THE DRAWINGS

FIG. 1 is a simplified schematic diagram showing a communication system, according to some embodiments of this disclosure;

FIG. 2 is a simplified schematic diagram of an access point (AP) of the communication network of the communication system shown in FIG. 1;

FIG. 3 is a simplified schematic diagram of a station (STA) of the communication system shown in FIG. 1;

FIG. 4 is a schematic diagram showing a high-level enhanced long range (ELR) physical layer protocol data unit (PPDU) frame format;

FIG. 5 is a schematic diagram showing the ELR frame format, according to some embodiments of this disclosure;

FIG. 6 is a schematic diagram showing the detail of the legacy preamble portion of the ELR frame format shown in FIG. 5, according to some embodiments of this disclosure; and

FIG. 7 is a schematic diagram showing an example 400 of eight (8) staggered long training fields (STGLTFs) with eight (8) pure data symbols.

### DETAILED DESCRIPTION

Embodiments disclosed herein relate to systems, apparatuses, methods, and non-transitory computer-readable storage devices for wireless communication employing enhanced long-range frame format. The wireless communication systems, apparatuses, and methods disclosed herein may be any suitable systems, apparatuses, and methods for transmitting wireless signals. Examples of such systems may be wireless local-area network (WLAN) Ultra High Reliability (UHR) systems (for example, IEEE 802.11bn or WI-FI® 8 systems), 5G or 6G wireless mobile communication systems, and the like.

a. System Structure

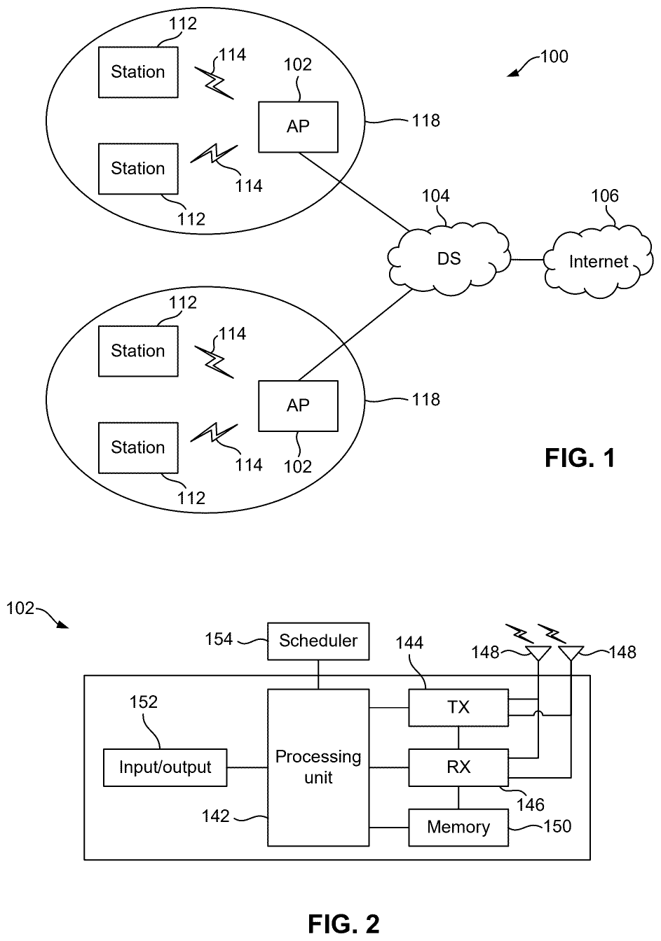

Turning now to FIG. 1, a communication system according to some embodiments of this disclosure is shown and is generally identified using reference numeral 100. As an example, the communication system 100 may be a WI-FI® system built under relevant standards such as IEEE 802.11 standard. As shown, the communication system 100 comprises a plurality of interconnected networking devices 102 such as a plurality of interconnected access points (APs; also called “base stations”) forming a distribution system (DS) 104 which is in turn connected to other networks such as the Internet 108 which may include a network of computers and subnets (intranets) or both, and incorporate protocols, such as Internet Protocol (IP), Transmission Control Protocol (TCP), User Datagram Protocol (UDP), and/or the like.

Each AP 102 is in wireless communication with one or more mobile or stationary stations 112 (STAs) through respective wireless channels 114 for providing wireless network connects thereto. Herein, the APs 102 and STAs 112 may be considered as different types of network nodes (or simply “nodes”) of the communication system 100. Each AP 102 and the STAs 112 connected thereto form a cell or basic service set (BSS) 118.

FIG. 2 is a simplified schematic diagram of an AP 102. As shown, the AP 102 comprises at least one processing unit 142 (also denoted at least one “processor”), at least one transmitter (TX) 144, at least one receiver (RX) 146 (collectively referred to as a transceiver), one or more antennas 148, at least one memory 150, and one or more input/output components or interfaces 152. A scheduler 154 may be coupled to the processing unit 142. The scheduler 154 may be included within or operated separately from the AP 102. Each of these components 142 to 154 may be implemented as one or more circuits (such as one or more electronic circuits and/or one or more optical circuits). Alternatively, the ensemble of these components 142 to 154 may be implemented as one or more circuits.

The processing unit 142 Is configured for performing various processing operations such as signal coding, data processing, power control, input/output processing, or any other suitable functionalities. The processing unit 142 may comprise a microprocessor, a microcontroller, a digital signal processor, a FPGA, an ASIC, and/or the like. In some embodiments, the processing unit 142 may execute computer-executable instructions or code stored in the memory 150 to perform various the procedures (otherwise referred to as methods) described below.

Each transmitter 144 may comprise any suitable structure for generating signals, such as control signals as described in detail below, for wireless transmission to one or more STAs 112. Each receiver 146 may comprise any suitable structure for processing signals received wirelessly from one or more STAs 112. Although shown as separate components, at least one transmitter 144 and at least one receiver 146 may be integrated and implemented as a transceiver. Each antenna 148 may comprise any suitable structure for transmitting and/or receiving wireless signals. Although common antennas 148 are shown in FIG. 2 as being coupled to both the transmitter 144 and the receiver 146, one or more antennas 148 may be coupled to the transmitter 144, and one or more other antennas 148 may be coupled to the receiver 146.

In some embodiments, an AP 102 may comprise a plurality of transmitters 144 and receivers 146 (or a plurality of transceivers) together with a plurality of antennas 148 for communication in its cell 118.

Each memory 150 may comprise any suitable volatile and/or non-volatile storage such as RAM, ROM, hard disk, optical disc, SIM card, solid-state memory, memory stick, SD memory card, and/or the like. The memory 150 may be used for storing instructions executable by the processing unit 142 and data used, generated, or collected by the processing unit 142. For example, the memory 150 may store instructions of software, software systems, or software modules that are executable by the processing unit 142 for implementing some or all of the functionalities and/or embodiments of the procedures performed by an AP 102 described herein.

Each input/output component 152 enables interaction with a user or other devices in the communication system 100. Each input/output device 152 may comprise any suitable structure for providing information to or receiving information from a user and may be, for example, a speaker, a microphone, a keypad, a keyboard, a display, a touch screen, a network communication interface, and/or the like.

Herein, the STAs 112 may be any suitable wireless device that may join the communication system 100 via an AP 102 for wireless operation. In various embodiments, a STA 112 may be a wireless electronic device used by a human or user (such as a smartphone, a cellphone, a personal digital assistant (PDA), a laptop, a desktop computer, a tablet, a smart watch, a consumer electronics device, and/or the like). A STA 112 may alternatively be a wireless sensor, an Internet-of-things (IoT) device, a robot, a shopping cart, a vehicle, a smart TV, a smart appliance, a wireless transmit/receive unit (WTRU), a mobile station, or the like. Depending on the implementation, the STA 112 may be movable autonomously or under the direct or remote control of a human, or may be positioned at a fixed position.

In some embodiments, a STA 112 may be a multimode wireless electronic device capable of operation according to multiple radio access technologies and incorporate multiple transceivers necessary to support such.

In addition, some or all of the STAs 112 comprise functionality for communicating with different wireless devices and/or wireless networks via different wireless links using different wireless technologies and/or protocols. Instead of wireless communication (or in addition thereto), the STAs 112 may communicate via wired communication channels to other devices or switches (not shown), and to the Internet 106. For example, a plurality of STAs 112 (such as STAs 112 in proximity with each other) may communicate with each other directly via suitable wired or wireless sidelinks.

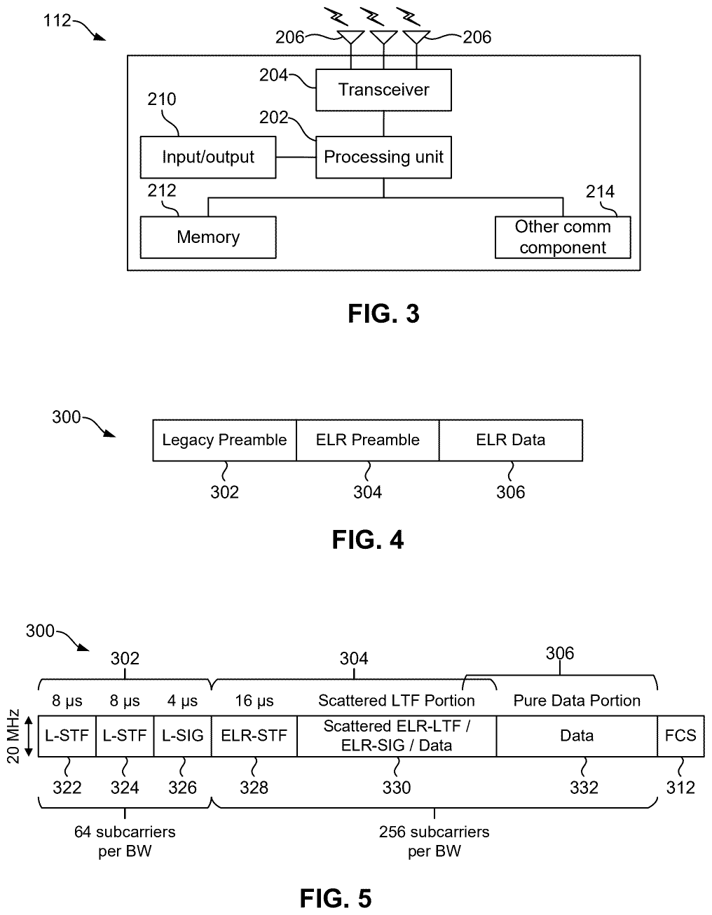

FIG. 3 is a simplified schematic diagram of a STA 112. As shown, the STA 112 comprises at least one processing unit 202, at least one transceiver 204, at least one antenna or network interface controller (NIC) 206, one or more input/output components 210, at least one memory 212, and at least one other communication component 214. Each of these components 202 to 214 may be implemented as one or more circuits (such as one or more electronic circuits and/or one or more optical circuits). Alternatively, the ensemble of these components 202 to 214 may be implemented as one or more circuits. In various embodiments, the STA 112 may also comprise other components as needed or as desired.

The processing unit 202 is configured for performing various processing operations such as signal coding, data processing, power control, input/output processing, or any other functionalities to enable the STA 112 to access and join the communication system 100 and operate therein. The processing unit 202 may also be configured to implement some or all of the functionalities of the STA 112 described in this disclosure. The processing unit 202 may comprise a central processing unit (CPU), a microprocessor, a microcontroller, a digital signal processor, an accelerator, a graphic processing unit (GPU), a tensor processing unit (TPU), a FPGA, or an ASIC. Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like. In some embodiments, the processing unit 202 may execute computer-executable instructions or code stored in the memory 212 to perform various processes described below.

The at least one transceiver 204 may be configured for modulating data or other content for transmission by the at least one antenna 206 to communicate with an AP 102. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The one or more input/output components 210 is configured for interaction with a user or other devices in the communication system 100. Each input/output component 210 may comprise any suitable structure for providing information to or receiving information from a user and may be, for example, a speaker, a microphone, a keypad, a keyboard, a display, a touch screen, and/or the like.

The at least one memory 212 is configured for storing instructions executable by the processing unit 202 and data used, generated, or collected by the processing unit 202. For example, the memory 212 may store instructions of software, software systems, or software modules that are executable by the processing unit 202 for implementing some or all of the functionalities and/or embodiments of the STA 112 described herein. Each memory 212 may comprise any suitable volatile and/or non-volatile storage and retrieval components such as RAM, ROM, hard disk, optical disc, SIM card, solid-state memory modules, memory stick, SD memory card, and/or the like.

The at least one other communication component 214 is configured for communicating with other devices such as other STAs 112 via other communication means such as a radio link, a BLUETOOTH® link (BLUETOOTH is a registered trademark of Bluetooth Sig Inc., Kirkland, WA, USA), a wired sidelink, and/or the like. Examples of the wired sidelink may be a USB cable, a network cable, a parallel cable, a serial cable, and/or the like.

In some embodiments, a STA 112 may comprise a plurality of transceivers 204 and a plurality of antennas 206 for communication with an AP 102.

In the communication between the AP 102 and the STA 112, a transmission from the STA 112 to the AP 102 is usually denoted an uplink (UL) and the wireless channel used therefor is denoted an uplink channel. A transmission from the AP 102 to the STA 112 is usually denoted a downlink (DL) and the wireless channel used therefor is denoted a downlink channel.

In physical layer, the frequency-time resource of the channel 114 is partitioned into physical layer protocol data units (PPDUs; also called “packets”), and the AP 102 or STA 112 transmits data as PPDUs or packets. Suitable modulation technologies may be used for communication between the AP 102 and the STA 112. For example, in some embodiments, orthogonal frequency-division multiplexing (OFDM) may be used wherein the channel 114 is composed of a plurality orthogonal subcarriers for communication between the AP 102 and the STA 112. Moreover, as there are usually a plurality of STAs 112 in communication with a same AP 102, suitable multiple-access technologies may be used. For example, in some embodiments, orthogonal frequency-division multiple access (OFDMA) may be used for communication between the AP 102 and STAs 112.

### B. Enhanced Long Range Frame Format

As described above, in physical layer, the frequency-time resource of the channel 114 is partitioned into PPDUs or packets, and the AP 102 or STA 112 transmits data as PPDUs or packets in accordance with a suitable PPDU frame format. Generally, a PPDU comprises one or more preamble portions followed by a data field. A PPDU may also comprise a frame check sequence (FCS) for error detection at the end of the frame.

In future Ultra High Reliability (UHR) wireless communication systems (such as IEEE 802.11bn or WI-FI® 8 systems), it is important to have a solution on the Long Range and Ultra Reliable packet design to meet the requirements (such as those described in relevant project authorization request (PARs)).

IEEE 802.11-24/873r0, entitled “Design Targets and Considerations for Enhanced Long Range,” to Liu, et al. provides a high-level enhanced long range (ELR) PPDU frame format 300 as shown in FIG. 4.

The legacy preamble portion 302 is to spoof the legacy devices. There may need an indication method of the ELR PPDU frame 300 (also simply denoted “ELR frame 300”) in the legacy preamble portion 302 for the ELR device (such as a ELR STA 112) to avoid the packet detection twice (once in legacy preamble portion 302 and another in ELR preamble portion 304), when the ELR device is close enough to the AP 102 to be able to detect both through the legacy preamble portion 302 and through the ELR preamble portion 304.

The double packet detection through both legacy preamble 302 and ELR preamble 304 can be a problem, when the ELR devices 112 are close enough to the AP 102 in detecting the packet. Moreover, IEEE 802.11-24/873r0 does not provide the detail of the ELR preamble 304 and ELR data 306.

The ELR frame 300 needs to be specially designed to provide more reliability to the frame and thus reach farther to the devices. The simplest way to achieve this goal is to repeat the Preamble, long training field (LTF), and data symbols, but then, the frame length would be an issue. Thus, there is a need for a solution to achieve better reliability, and at the same time, to keep the throughput less sacrificed.

In the following, various embodiments of the ELR frame format 300 are described with details of various embodiments of the ELR preamble portion 304 and ELR data portion 306 thereof. In these embodiments, the ELR short training field (STF), LTF, and/or signal (SIG) field may be in different formats compared to the legacy preamble portion 302.

The ELR frame format 300 and related methods may be used in various wireless communication devices such as WI-FI® APs 102 and/or STAs 112 (for example, WI-FI® 8 devices), and may be particularly useful for wireless communication devices with limited computational capability for long-range wireless communications with a low-rate transmission.

FIG. 5 is a schematic diagram showing an ELR frame 300, according to some embodiments of this disclosure, wherein the ELR frame 300 is described using an example of an OFDMA scenario having a bandwidth (BW) of 20 megahertz (MHz).

As shown, the ELR frame 300 comprises a legacy preamble portion 302, a ELR preamble portion 304, a ELR data portion 306, and an FCS 312. The legacy preamble portion 302 occupies 64 subcarriers per BW. The ELR preamble portion 304 and the ELR data portion 306 occupy 256 subcarriers per BW. The legacy preamble portion 302 is for spoofing the Non-ELR devices, and comprises a legacy STF (L-STF) 322 of eight (8) micro-seconds (μs), a legacy LTF (L-LTF) 324 of 8 μs, and a legacy SIG (L-SIG) 326 of 4 μs. The ELR preamble portion 304 comprises a ELR STF 328 of 16 μs, and a scattered LTF portion 330 (which may be used as scattered ELR-LTF, ELR-SIG, and/or data). The ELR data portion 306 comprises a pure data portion 332. When the scattered LTF portion 330 comprises data, the data of the scattered LTF portion 330 may also be considered as a part of the ELR data portion 306. In particular, the ELR-LTF, ELR-SIG, and ELR data may be mixed in a symbol since the ELR-LTF is not occupying the entire subcarriers. If the ELR data is sufficiently mixed with ELR-LTF, then, the tones or subcarriers may be fully assigned with data only, which is called a pure data portion 306.

As described above, the use of the legacy preamble portion 302 may cause the double packet detection problem through both the legacy preamble 302 and the ELR preamble 304 by an ELR device 114 being close enough to the AP 102, if the short training sequences (STS) for the ELR-STF 328 continue to use the high efficiency (HE) STS (HE STS) of the HE multi-user (MU) PPDU, that is, the same number of samples repeat per time period between L-STF and ELR-STF.

As those skilled in the art understand, the IEEE 802.11 family includes a number of standards (also called “versions” or “modes”), such as non-high-throughput (non-HT; IEEE 802.11 versions that predates IEEE 802.11n), HT mixed format (IEEE 802.11n), very-high-throughput (VHT; IEEE 802.11ac), HE (IEEE 802.11ax or WI-FI® 6), extremely high throughput (EHT; IEEE 802.11be or WI-FI® 7), and the like. The PPDU frames of later standards generally comprise a legacy preamble for backward compatibility.

In prior art, a device 102 or 112 uses a combination of various fields in the preambles of a PPDU to detect the mode thereof. For example, the rate subfield 342 in the L-SIG of the legacy preamble is not practically being used to indicate any meaningful information, and the rate subfield 342 has been fixed to 6 megabits per second (Mbps) (that is, MCSO) since IEEE 802.11n. Thus, if the rate subfield is not 6 Mbps, then the PPDU is regarded as non-HT. In fact, in non-HT PPDUs, the length subfield modulo three (3) equals to zero (0).

As another example, a ceiling operation of the value of the length subfield in the L-SIG of the legacy preamble divided by three (3) is used in prior art to determine the frame length. Therefore, different values of the length subfield that, when divided by 3, give rise to the same quotient but different remainders (being zero (0), one (1), or two (2)) give rise to the same frame length. Therefore, recent IEEE 802.11 standards in prior art leverage this fact and defined that, if the rate subfield is 6 Mbps, and the length subfield in the L-SIG of the legacy preamble modulo 3 is 1 or 2, then the PPDU is IEEE 802.11ax (indicating the HE single-user (SU) PPDU, HE extended range SU PPDU, or the HE MU PPDU); on the other hand, if the rate subfield is 6 Mbps, and the length subfield in the L-SIG of the legacy preamble modulo 3 is 0, then the PPDU is IEEE 802.11n, IEEE 802.11ac, or IEEE 802.11be.

In some embodiments, the communication system 100 expands this idea and uses L-SIG 326 to indicate the ELR frame for avoiding the double packet detection issue.

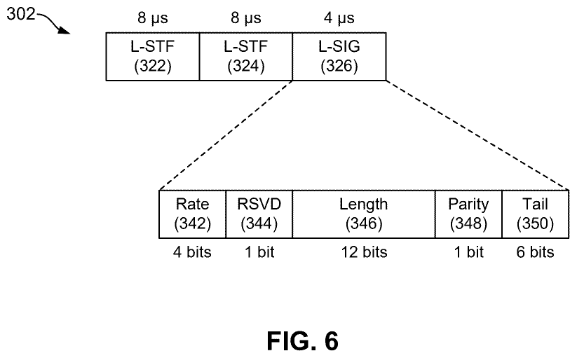

FIG. 6 is a schematic diagram showing the detail of the legacy preamble portion 302. In these embodiments, the L-SIG 326 comprises a rate subfield 342 of four (4) bits, a reserved (RSVD) subfield 344 of one (1) bit, a length subfield 346 of 12 bits, a parity subfield 348 of one bit, and a tail portion 350 of six (6) bits.

In these embodiments, the ELR frame is indicated by the rate subfield 342 having a value not equal to 6 Mbps (for example, nine (9) Mbps), and the length subfield 346 having a value that is not an integer multiple of three (3) (that is, the value modulo 3 is 1 or 2).

Accordingly, when an ELR device reads the non-6 Mbps value in the rate subfield 342, then, it determines that the PPDU frame is either a non-HT frame or an ELR frame. Then, the ELR device reads the length subfield 346 and calculates the value thereof modulo 3. If the calculation result is non-zero, then, the PPDU frame is an ELR frame; otherwise, it is a non-HT frame.

The legacy devices may consider the PPDU frame as a non-HT frame after discovering the non-6 Mbps value of the rate subfield 342. The legacy devices may continue to decode the data portion with consideration that the PPDU frame may be a Non-HT PPDU, and discover the receiver address (RA) in the MAC header. If this RA does not correspond to the received device, then, the received device may ignore the packet at this stage.

In some embodiments, the ELR-STF 328 is used to indicate the ELR frame for avoiding the double packet detection issue. More specifically, the ELR-STF 328 in these embodiments may be set with an STS that creates a different number of samples being repeated over the same time period from the STS in the L-STF 324.

For example, the ELR-STF 328 may use the HE STS (High Efficiency WLAN (HEW) short training sequence; also called “HES”) of the HE trigger-based (TB) PPDU, which is HES_{-120:8:120}={M, 0, −M}·(1+j)/\sqrt{2},
where M={−1, −1, −1, 1, 1, 1, −1, 1, 1, 1, −1, 1, 1, −1, 1}

In one example, the guard interval (GI) for the ELR-STF is 3.2 μs, and thus, the length of the symbol in ELR-STF 328 is 16 μs, where there are 10 repeated pulses, that is, 5 pulses (5 correlation peaks) per 8 μs, which is different from 10 pulses (10 correlation peaks) per 8 μs in L-STF 324. An ELR device may check the packet detection (PD; which determines whether a packet arrives) with the ELR-STF described above to discover the ELR frame type, and ignore the legacy preamble portion, regardless whether the ELR device 112 is far or near the AP 102.

In some embodiments, the staggered LTF (STGLTF) is used for the channel estimation (wherein the LTS occupies subcarriers in a staggered manner within symbols, without utilizing the same tones in every symbol), and, for the scattered LTF portion 330 of the ELR frame 300 (see FIG. 5), the STGLTF is applied to the ELR-LTF, and the ELR-SIG and/or data is allocated in the subcarriers where the long training sequences (LTS) of the ELR-LTF are not occupied.

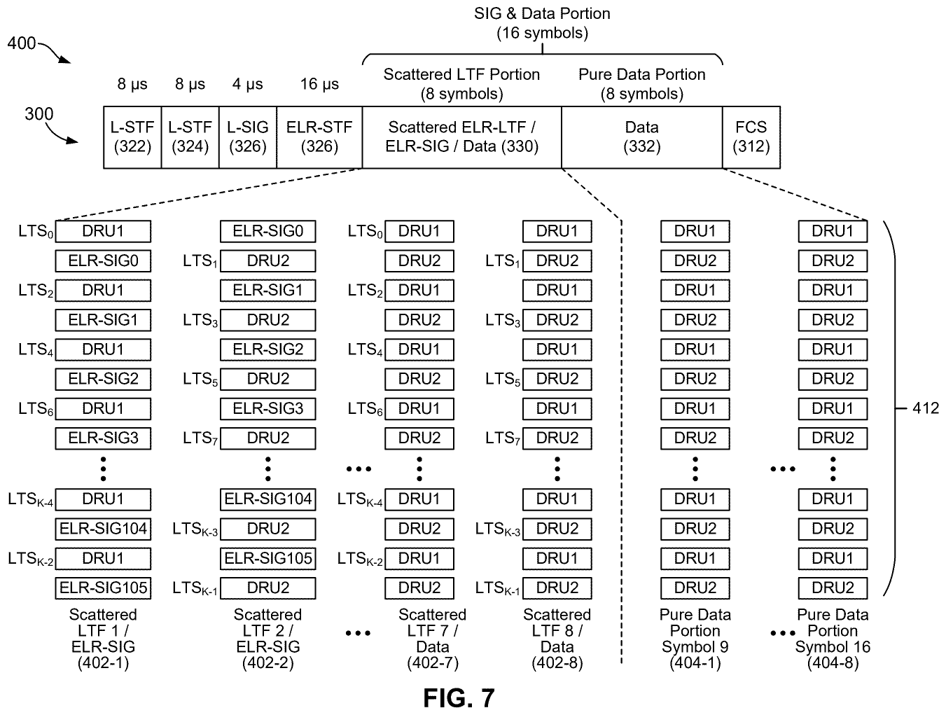

FIG. 7 is a schematic diagram showing an example 400 of eight (8) STGLTFs with eight (8) pure data symbols 404-1 to 404-8 in the pure data portion 332. In this example, one symbol is allocated in Scattered LTF 1 (402-1) for the ELR-SIG (having 53 bits of ELR-SIG information), while a half of the tones may be used for the LTS. As those skilled in the art will appreciate, the contents of ELR-SIG0 can be repeated in ELR-SIG1 and they do not have to repeat tone-by-tone. In other words, just 53 bits of information in ELR-SIG0 are repeated in ELR-SIG1, if they need to be repeated.

In some embodiments, additional scattered LTFs may also be allocated for the ELR-SIG to repeat the ELR-SIG to provide more reliable detection of SIG or if there are more than 53 bits for SIG information. For example, the frame example in FIG. 7 shows the two repeated ELR-SIGs 402-1 and 402-2, each having 53 bits of ELR-SIG information, that is, the same ELR-SIG 402-1 is repeated in the scattered LTF 2 (402-2) for the reliable detection of ELR-SIG field, and of course, the ELR-SIGs 402-1 and 402-2 can be different information in case there may need 106-bit ELR-SIG information. In some embodiments, the ELR-SIGs in the 402-1 and 402-2 may be repeated on to the third and fourth Scattered LTF symbols, so as to repeat the 106 tone ELR-SIG for the reliable ELR-SIG detection.

In some embodiments, the ELR-SIGs may be repeated multiple times as needed or desired to provide further reliability to the detection of ELR-SIGs.

In this example, two STAs 112 may be scheduled with one STA on DRU 1 and the other STA on DRU 2. Of course, a single STA 112 may be scheduled on all the remaining tones after allocating LTS.

In the embodiments where the HE STS of the HE TB PPDU is used in the ELR-STF 328, there are 10 repeated samples over the 16 μs period, and the first 6 to 7 repeated samples may be used for the packet detection (PD) and the remaining 3 to 4 repetitions may be used for the coarse carrier frequency offset (CFO) correction. In some embodiments, another repeated ELR-STF symbol may be used for better coarse CFO correction in the ELR-STF, wherein the two ELR-STF symbols provide 20 repeated samples over the 32 μs period, which may assign the first 6 to 7 repetition for the PD and the remaining 13 to 14 repetitions for averaging the coarse CFO.

Thus, the ELR-LTF is used for channel estimation and for fine CFO correction. In some embodiments, an auto-correlation may be calculated for the ELR-LTF over the 256-sample period for fine CFO correction, wherein a larger correlation window size may lead to finer CFO correction. Therefore, the ELR-LTF may provide finer CFO correction than the L-LTF. In some embodiments, the fine CFO correction may be repeated using the auto-correlation multiple times in accordance with the ELR-LTF symbol repetitions.

The ELR PPDU frame format 300 disclosed herein assigns 256 subcarriers per 20 MHz BW for the ELR preamble portion 304, which provides improved frame efficiency and easier packet detection comparing to prior-art frame formats.

In some embodiments, the ELR-STF can be defined using the HE STS of HE TB PPDU, which provides improved packet detection and coarse CFO correction.

In accordance with the ELR PPDU frame format 300 disclosed herein, suitable methods are also disclosed for indicating the ELR frame in the legacy preamble portion to avoid the double packet detection problem (which may otherwise occur with the L-STF and ELR-STF, in case ELR-STF creates the same number of samples being repeated over a time period as the L-STF).

In some embodiments, the ELR-SIG field may be allocated in the staggered LTF portion and the ELR-SIG may be repeated as needed or desired, which does not cause any overhead issue in the ELR frame.

Herein, various embodiments of the ELR frame format and communication method using the ELR frame format are disclosed. In some embodiments, the communication method disclosed herein assigns 256 subcarriers per 20 MHz for the ELR preamble portion (including the pure data portion), which provides frame efficiency and easier packet detection.

In some embodiments, the ELR-STF may be defined using the HE STS of HE TB PPDU, thereby providing improved packet detection and coarse CFO correction.

In some embodiments, the communication method disclosed herein indicates the ELR frame in the legacy portion to avoid the double packet detection case which may otherwise occur with the L-STF and ELR-STF, in case ELR-STF creates the same number of samples being repeated over a time period as the L-STF. Thus, when the PD periods are the same between L-STF and ELR-STF, the ELR frame provides indication in the legacy preamble portion, which provides the solution to avoid the double packet detection.

In some embodiments, the communication method disclosed herein allocates the ELR-SIG field in the staggered LTF portion and may repeat the ELR-SIG as needed, thereby avoiding the overhead issue in the ELR frame with the repeated SIG field.

### C. Acronyms, Abbreviations, and Definition of Some Terms

| Full Name | Acronym/Abbreviation/Initialism |
|---|---|
| Ultra High Reliability | UHR |
| Project Authorization Request | PAR |
| Enhanced Long Range | ELR |
| Bandwidth | BW |
| Beamforming | BF |
| Modulation and Coding System | MCS |
| Long Training Sequence | LTS |
| Packet Detection | PD |
| Long Training Field | LTF |
| Distributive Resource Unit | DRU |
| Short Training Field | STF |
| SIG Field | SIG |
| High Efficiency | HE |
| Multi User | MU |
| PHY Protocol Data Unit | PPDU |
| Physical Layer | PHY |
| Single User | SU |
| High Throughput | HT |
| Trigger Based | TB |
| HE STS | HES |
| Staggered LTF | STGLTF |
| Short Training Sequence | STS |
| Carrier Frequency Offset | CFO |

Herein, the term “predefined” (for example, a “predefined” item such as a “predefined” parameter) refers to an item defined before the method disclosed herein is performed (for example, defined as a system design parameter such as defined by relevant standards).

Herein, the term “preconfigured” (for example, a “preconfigured” item such as a “preconfigured” parameter) refers to an item configured by a suitable apparatus before a certain even occurs.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

Herein, various embodiments are described. In various embodiments, the methods disclosed herein may be implemented as hardware, software, firmware, or a combination thereof, and may be implemented in any suitable form. Depending on the functionalities of various features of the methods disclosed herein, some features may be implemented on the network side (such as in one or more APs), some other features may be implemented on the STA side, and/or yet some other features may be implemented on both the AP and the STA sides. Depending on the functionalities of various features of the methods disclosed herein, some features may be implemented on the transmitting side (such as in one or more APs and/or one or more STAs for transmission), some other features may be implemented on the receiving side (such as in one or more APs and/or one or more STAs for receiving), and/or yet some other features may be implemented on both the transmitting and the receiving sides.

For example, in some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the various embodiments and/or features disclosed herein may be customized and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A communication method comprising:
transmitting or receiving a physical layer protocol data unit (PPDU);
wherein the PPDU comprises a first, legacy preamble, a second preamble, and a data piece;
wherein the first preamble comprises a legacy signal (L-SIG) field; and
wherein the L-SIG field comprises a rate subfield indicating a rate different to 6 megabits per second (Mbps), and a length subfield whose value modulo 3 is nonzero.

2. The communication method of claim 1, wherein the PPDU is an orthogonal frequency-division multiple access (OFDMA) PPDU;
wherein the second preamble comprises a long training field (LTF) portion;
wherein the LTF portion comprises a symbol in a plurality of tones; and
wherein half of the plurality of tones of the symbol are for carrying signal (SIG) information and another half of the plurality of tones of the symbol are for carrying long training sequences (LTS).

3. The communication method of claim 2, wherein the LTF portion comprises a first symbol for carrying signal (SIG) information and long training sequences (LTS); and
wherein, in the first symbol, the SIG information and the LTS are distributed in a plurality of tones such that each pair of neighboring tones for carrying the SIG information are spaced by at least one tone for carrying the LTS.

4. The communication method of claim 1, wherein the PPDU comprises a legacy signal (L-SIG) field, at least one enhanced long range (ELR) short training field (ELR-STF), or a combination thereof for avoiding double detection of the PPDU;
wherein the L-SIG field comprises a rate subfield indicating a rate different to 6 megabits per second (Mbps), and a length subfield whose value modulo 3 is nonzero; and
wherein each of the at least one ELR-STF comprises a short training sequence (STS) corresponding to a predefined or predetermined number of repeated pulses over a predefined or predetermined time period.

5. The communication method of claim 1, wherein the STS corresponds to 10 repeated pulses over 16 microseconds (μs); and
wherein the first 6 or 7 pluses of the 10 repeated pulses are used for packet detection (PD), and the remaining pulses of the 10 repeated pulses are used for coarse carrier frequency offset (CFO) correction.

6. The communication method of claim 1, wherein the PPDU comprises two ELR-STFs, thereby giving rise to two STS correspond to 20 repeated pulses over 32 μs; and
wherein the first 6 or 7 pluses of the 20 repeated pulses are used for PD, and the remaining pulses of the 20 repeated pulses are used for coarse carrier frequency offset (CFO) correction.

7. The communication method of claim 2, wherein the LTF portion further comprises a second symbol also for carrying the SIG information and the LTS;
wherein, in the second symbol, the SIG information and the LTS are distributed in the plurality of tones such that each pair of neighboring tone for carrying the SIG information are spaced by at least one tone for carrying the LTS; and
wherein the tones carrying the SIG information in the first symbols are different to the tones carrying the SIG information in the second symbols.

8. An apparatus comprising:
one or more non-transitory, computer-readable storage media; and one or more processors functionally connected to the one or more non-transitory, computer-readable storage media; wherein the one or more non-transitory, computer-readable storage media contain computer-executable instructions; and wherein the instructions, when executed, cause the one or more processors to perform the method of claim 1.

9. The apparatus of claim 8, wherein the STS corresponds to 10 repeated pulses over 16 microseconds (μs); and
wherein the first 6 or 7 pluses of the 10 repeated pulses are used for packet detection (PD), and the remaining pulses of the 10 repeated pulses are used for coarse carrier frequency offset (CFO) correction.

10. The apparatus of claim 8, wherein the PPDU comprises two ELR-STFs, thereby giving rise to two STS correspond to 20 repeated pulses over 32 μs; and
wherein the first 6 or 7 pluses of the 20 repeated pulses are used for PD, and the remaining pulses of the 20 repeated pulses are used for coarse CFO correction.

11. The apparatus of claim 8, wherein the PPDU is an orthogonal frequency-division multiple access (OFDMA) PPDU;
wherein the PPDU comprises a long training field (LTF) portion;
wherein the LTF portion comprises a first symbol for carrying signal (SIG) information and long training sequences (LTS); and
wherein, in the first symbol, the SIG information and the LTS are distributed in a plurality of tones such that each pair of neighboring tones for carrying the SIG information are spaced by at least one tone for carrying the LTS.

12. The apparatus of claim 11, wherein the LTF portion further comprises a second symbol also for carrying the SIG information and the LTS;
wherein, in the second symbol, the SIG information and the LTS are distributed in the plurality of tones such that each pair of neighboring tones for carrying the SIG information are spaced by at least one tone for carrying the LTS; and
wherein the tones carrying the SIG information in the first symbols are different to the tones carrying the SIG information in the second symbols.

13. One or more non-transitory computer-readable storage media comprising computer-executable instructions, wherein the instructions, when executed, cause one or more circuits to perform the method of claim 1.

14. The one or more non-transitory, computer-readable storage media of claim 13, wherein the STS corresponds to 10 repeated pulses over 16 microseconds (μs).

15. The one or more non-transitory, computer-readable storage media of claim 14, wherein the first 6 or 7 pluses of the 10 repeated pulses are used for packet detection (PD), and the remaining pulses of the 10 repeated pulses are used for coarse carrier frequency offset (CFO) correction.

16. The one or more non-transitory, computer-readable storage media of claim 13, wherein the PPDU comprises two ELR-STFs, thereby giving rise to two STS correspond to 20 repeated pulses over 32 μs; and
wherein the first 6 or 7 pluses of the 20 repeated pulses are used for PD, and the remaining pulses of the 20 repeated pulses are used for coarse CFO correction.

17. The one or more non-transitory, computer-readable storage media of claim 13, wherein the STS is a High Efficiency (HE) WLAN short training sequence HE STS.

18. The one or more non-transitory, computer-readable storage media of claim 17, wherein the HE STS is HES_{-120:8:120}={M, 0, −M}·(1+j)/\sqrt{2}, where M={−1, −1, −1, 1, 1, 1, −1, 1, 1, 1, −1, 1, 1, −1, 1}.

19. The one or more non-transitory, computer-readable storage media of claim 13, wherein the PPDU is an orthogonal frequency-division multiple access (OFDMA) PPDU;
wherein the PPDU comprises a long training field (LTF) portion;
wherein the LTF portion comprises a first symbol for carrying signal (SIG) information and long training sequences (LTS); and
wherein, in the first symbol, the SIG information and the LTS are distributed in a plurality of tones such that each pair of neighboring tones for carrying the SIG information are spaced by at least one tone for carrying the LTS.

20. The one or more non-transitory, computer-readable storage media of claim 19, wherein the LTF portion further comprises a second symbol also for carrying the SIG information and the LTS;
wherein, in the second symbol, the SIG information and the LTS are distributed in the plurality of tones such that each pair of neighboring tones for carrying the SIG information are spaced by at least one tone for carrying the LTS; and
wherein the tones carrying the SIG information in the first symbols are different to the tones carrying the SIG information in the second symbols.
